(19) United States
(12) Patent Application Publication
(10) Pub. No.: US 2021/0396355 A1
(43) Pub. Date: Dec. 23, 2021

(54) SOLID STATE HYDROGEN STORAGE DEVICE INCLUDING PLATE TYPE HEAT EXCHANGER

(71) Applicants: HYUNDAI MOTOR COMPANY, Seoul (KR); KIA MOTORS CORPORATION, Seoul (KR)

(72) Inventors: Young Jin CHO, Gimhae-si (KR); Kyung Moon LEE, Uiwang-si (KR); Byeong Soo SHIN, Uiwang-si (KR); Hoon Mo PARK, Seongnam-si (KR); Dong Hoon NAM, Suwon-si (KR)

(73) Assignees: HYUNDAI MOTOR COMPANY, Seoul (KR); KIA MOTORS CORPORATION, Seoul (KR)

(21) Appl. No.: 17/073,579

(22) Filed: Oct. 19, 2020

(30) Foreign Application Priority Data
Jun. 17, 2020 (KR) 10-2020-0073947

(51) Int. Cl. F17C 3/02

(52) U.S. Cl. CPC F17C 3/02

(57) ABSTRACT

A solid state hydrogen storage device includes: a solid state hydrogen storage material in which hydrogen is stored; a heat exchanger in a plate shape that is inserted into the solid state hydrogen storage material and exchanges heat with the solid state hydrogen storage material through contact with the solid state hydrogen storage material; a storage container in which the solid state hydrogen storage material and the heat exchanger are accommodated; and a cap connected to an upper portion of the storage container and configured to seal the interior of the storage container.

### CROSS REFERENCE TO RELATED APPLICATION

This application claims priority to and the benefit of Korean Patent Application No. 10-2020-0073947, filed on Jun. 17, 2020, the entire contents of which are incorporated herein by reference.

### FIELD

The present disclosure relates to a solid state hydrogen storage device by which a plate type heat exchanger exchanges heat through contact with a solid state hydrogen storage material.

### BACKGROUND

The statements in this section merely provide background information related to the present disclosure and may not constitute prior art.

Fossil fuels, which have been an energy source mainly used until now, are limited in their amounts, and environmental contaminations due to pollution materials generated from burning the fossil fuels have become social issues.

When hydrogen is used as a fuel, it does not generate a product that is harmful to the environment except for an extremely small amount of a nitrogen oxide and can be easily stored in various forms such as a liquid state gas, a metal hydride, and thus is spotlighted as a next-generation alternative energy.

In order to use hydrogen as an energy source, a technology for producing, storing, and transporting hydrogen is required. In particular, the technology for safely storing and transporting hydrogen is essential for commercialization of hydrogen as an alternative energy source.

A liquid state hydrogen storage technology requires high costs for liquefying hydrogen, and the temperature of hydrogen has to be maintained. A gas state hydrogen storage technology requires pressure equipment that can endure a high pressure of 150 atm., and has a high level of dangers when an impact is applied thereto.

A solid state hydrogen storage technology is a technology of storing hydrogen on a surface or in the interior of a material. The solid state hydrogen storage technology is a method of storing hydrogen by using a principle in which the volume of hydrogen decreases if the hydrogen is adsorbed to a specific solid material, and the hydrogen adsorbed and stored in this way may be extracted by heating and depressurizing the hydrogen again. A method of physically adsorbing hydrogen correspond to a method of adsorbing hydrogen molecules weakly but generating no chemical reaction. Through the chemical adsorption, hydrogen molecules form metallic covalent bonds or ion bonds through reactions with a surface of a material, and hydrogen is stored through the chemical adsorption of generating a hydrate with hydrogen.

The solid state hydrogen storage technology can store hydrogen at a high density as compared with other commercialized hydrogen storage technologies. According to a conventional solid state hydrogen storage device, cartridge heaters in the form of rods or tubes are inserted into a solid state hydrogen storage material for heat exchange.

We have discovered that since a contact surface of the cartridge heaters with the solid state hydrogen storage material is limited, it is difficult to secure an area for heat exchange. In particular, because the temperature of the contact surface is high, the temperature decreases as the distance from the contact surface increases. In this case, a temperature rise is concentrated around the contact surface and the material may deteriorate.

Tolerances are required for assembling of the cartridge heater, and because the contact surface is spaced apart by the tolerances, efficiency decreases in the case of heat exchange. Further, since the cartridge heat is inserted, the overall volume and weight increase and cause an increase in manufacturing costs.

### SUMMARY

The present disclosure provides a solid state hydrogen storage device in which a heat exchanger has a plate shape and is inserted into a solid state hydrogen storage material whereby a contact surface for the heat exchanger is secured, heat exchange efficiency is improved, and the volume and weight thereof are reduced.

In accordance with an aspect of the present disclosure, a solid state hydrogen storage device may include: a solid state hydrogen storage material in which hydrogen is stored; a heat exchanger forming a plate shape and configured to be inserted into the solid state hydrogen storage material and exchange heat with the solid state hydrogen storage material through contact with the solid state hydrogen storage material; a storage container configured to accommodate the solid state hydrogen storage material and the heat exchanger; and a cap connected to an upper portion of the storage container and configured to seal the interior of the storage container.

The heat exchanger may include a plurality of plate type heaters, the plate type heaters are disposed upwards and downwards at a regular interval, and the solid state hydrogen material is inserted between the plate type heaters.

In one form, each of the plate type heaters may be provided with metal plates respectively disposed on the upper and lower sides thereof and may include a heat radiating part that radiates heat in the interior thereof, and the heat radiating part has a constant length per unit area.

A surface of each of the metal plates, which contacts the heat radiating part, may be coated with copper or aluminum.

In another form, the heat radiating part may include a plurality of circular heat radiating parts coaxially arranged around a center of the heat exchanger with irregular intervals such that among the plurality of circular heat radiating parts, a diameter of an outer circular heat radiating part is larger than a diameter of an inner circular heat radiating part.

The heat radiating parts may be heating wires having shapes, in which polygonal shapes are repeated to have irregular intervals while the center of the heat exchanger is taken as the centers thereof, to have a constant length per unit area.

The solid state hydrogen storage material may have a stack structure in which a plurality of disks are stacked, and the heat exchanger may be inserted between the disks to exchange heat with the disks.

The cross-section of the plate-type heat exchanger may be the same as the cross-section of the disks.

The solid state hydrogen storage material may include a compression member inserted between the stacked disks and a sealing member that seals opposite ends of the compression member and presses the disks upwards and downwards.

The solid state hydrogen storage material may store hydrogen in any one of the forms of LaNi₅H₆, sodium aluminum hydride (NaAlH₄), and magnesium amide (Mg(NH₂)₂).

According to a solid state hydrogen storage device including a plate type heat exchanger according to the present disclosure, a heat exchanger has a plate shape and is inserted into a solid state hydrogen storage material whereby a contact surface for the heat exchanger is secured so that the material of the solid state hydrogen storage material can be prevented from deteriorating as heat may be uniformly delivered to the entire area of the solid state hydrogen material.

Further, because the plate type heat exchanger is inserted into the solid state hydrogen storage material, the solid state hydrogen storage material can maintain a compact shape after being assembled, and can be manufactured regardless of the size of the solid state hydrogen storage material.

Further, due to the small thickness and the wide area of the plate type heat exchanger, heat can be easily transferred to the solid state hydrogen storage material whereby thermal efficiency can be improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a solid state hydrogen storage device including a plate type heat exchanger in one form of the present disclosure;

FIG. 2 is a view of a solid state hydrogen storage device including another plate type heat exchanger in one form of the present disclosure;

FIG. 3 is a cross-sectional view of the solid state hydrogen storage device including a plate type heat exchanger according to one form of the present disclosure;

FIGS. 4 and 5 are views of a heat radiating part of the solid state hydrogen storage device including a plate type heat exchanger in some forms of the present disclosure; and

FIG. 6 is a perspective view of a solid state hydrogen storage material of the solid state hydrogen storage device including a plate type heat exchanger in another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A specific structural or functional description of some forms of the present disclosure is given merely for the purpose of describing exemplary forms according to the present disclosure.

Various changes and modifications may be made to the forms according to the present disclosure, and therefore particular forms will be illustrated in the drawings and described in the specification or application. However, it should be understood that forms according to the concept of the present disclosure are not limited to the particular disclosed forms, but the present disclosure includes all modifications, equivalents, and alternatives falling within the spirit and scope of the present disclosure.

In the case where an element is referred to as being “connected” or “accessed” to other elements, it should be understood that not only the element is directly connected or accessed to the other elements, but also another element may exist between them. Contrarily, in the case where a component is referred to as being “directly connected” or “directly accessed” to other component, it should be understood that there is no component therebetween. The other expressions of describing a relation between structural elements, i.e. “between” and “merely between” or “neighboring” and “directly neighboring”, should be interpreted similarly to the above description.

Hereinafter, some exemplary forms of the present disclosure will be described in detail with reference to the accompanying drawings.

A conventional solid state hydrogen storage device exchanges heat by inserting heaters in the form of a cartridge into a solid state hydrogen storage material 100. Contact areas of the cartridge heaters with the slid state hydrogen storage material 100 are limited, and thus a heating time is long. Accordingly, power consumption is high, causing heat exchange loss.

Further, the conventional cartridge heaters are inserted in the form of a rod, heat is locally transferred, and the heat transfer is unbalanced. Because the temperature distribution of portions contacting surfaces of the heaters and other portions is not uniform, the solid state hydrogen storage material 100 deteriorates.

Further, if tolerances are generated when the heaters are assembled in the form of a rod or a tube, gaps are present on the contact surfaces, deteriorating thermal conductivity, and the assembling process for the heaters is difficult if there is no tolerance.

The present disclosure provides a solid state hydrogen storage device that may store and transport hydrogen by using a solid state hydrogen storage material 100, to which hydrogen is adsorbed or occluded, and a heat exchanger that exchanges heat with the solid state hydrogen storage material has a plate shape.

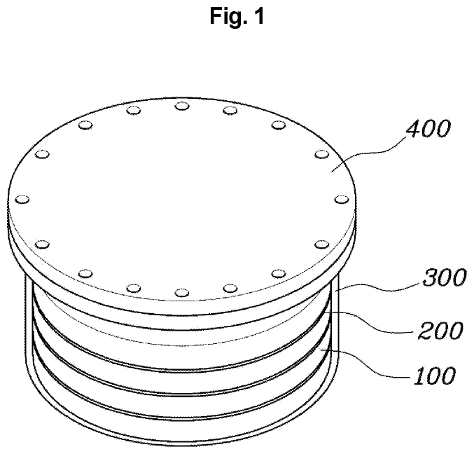

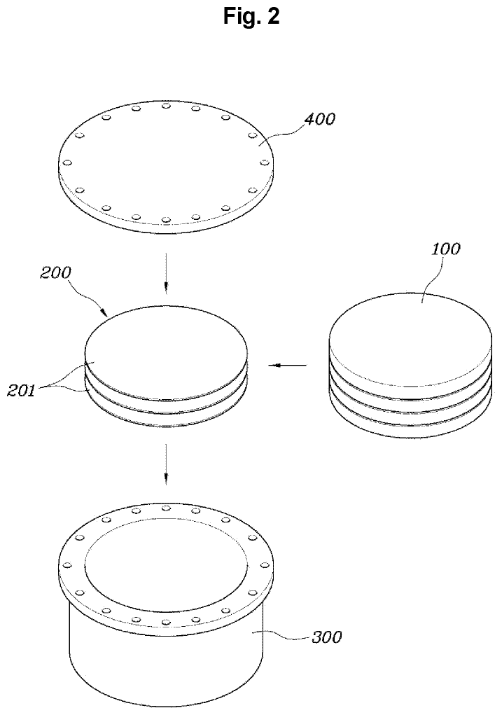

FIG. 1 is a perspective view of a solid state hydrogen storage device including a plate type heat exchanger 200 according to one form of the present disclosure. FIG. 2 is a view illustrating a solid state hydrogen storage device including another plate type heat exchanger 200 according to another form of the present disclosure.

Referring to FIGS. 1 and 2, the solid state hydrogen storage device may include a solid state hydrogen storage material 100, a heat exchanger 200, a storage container 300, and a cap 400.

The solid state hydrogen storage material 100 is a material that adsorbs or occludes hydrogen in the form of a metal hydride by pressing hydrogen and desorbs or unblocks hydrogen with pressure or heat. The solid state hydrogen storage material 100 may reversibly react with hydrogen to receive hydrogen atoms in grids of crystals and form a metal hydride. The formation and decomposition of a hydride is as in Formula 1.

M+n/2H₂⇔MHₙ [Formula 1]
(M: solid state hydrogen storage material 100)

The solid state hydrogen storage material may be any one of LaNi5H₆, sodium aluminum hydride (NaAlH₄), and magnesium amide (Mg(NH₂)₂). The solid state hydrogen storage material 100 may store hydrogen more compactly than liquid state hydrogen.

A process of occluding or adsorbing hydrogen in the solid state hydrogen storage material 100 is an exothermic reaction, and a process of unblocking or desorbing hydrogen is an endothermic reaction. Accordingly, a reaction of absorbing or emitting hydrogen may be controlled by heating or cooling the solid state hydrogen storage material 100. The heat exchanger 200 is a device that controls storage or emission of hydrogen through heat exchange with the solid state hydrogen storage material 100.

The heat exchanger 200 may have a plate shape. Unlike the conventional technology, the heat exchanger 200 may have a plate shape such that the solid state hydrogen storage material 100 is inserted into the heat exchanger 200. The insertion form corresponds to a structure in which the plate type heat exchanger 200 is inserted between the solid state hydrogen storage materials 100, and this expression has the same meaning if it is expressed that the heat exchanger 200 is inserted into the solid state hydrogen storage material 100. Through this, a contact area of the heat exchanger 200 with the solid state hydrogen storage material 100 can be secured maximally, and the heat exchanger 200 can exchange heat in a conduction scheme due to the contact surface.

Since the heat exchanger 200 has a plate shape, heat can be transferred uniformly as a whole. The entire surface of the heat exchanger 200 is heated at a uniform temperature, and the heat exchanger 200 exchanges heat with the solid state hydrogen storage material 100 whereby deterioration of the solid state hydrogen storage material 100 can be prevented.

Although a plurality of heaters 201 are provided for heat transfer in the conventional technology, the present disclosure allows uniform heating, and thus a compact device having a simple overall configuration and having a light weight and a small volume can be manufactured.

Further, because the vertical thickness for heat transfer is smaller than the horizontal thickness for heat transfer, a time for emission of hydrogen can be shortened.

The solid state hydrogen storage material 100 and the heat exchanger 200 may be accommodated in the storage container 300, and the cap 400 may be connected to an upper portion of the storage container 300 to seal the interior of the storage container 300. The storage container 300 may have a cylinder shape.

Further, as illustrated in FIGS. 1 and 2, the heat exchanger 200 according to one form of the present disclosure may be configured such that a plurality of heaters 201 are disposed vertically at a regular interval. The heaters 201 may be inserted into the sold state hydrogen storage material 100.

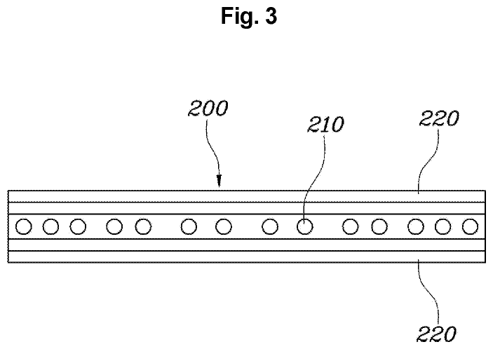

FIG. 3 is a cross-sectional view of a heater 201 of the solid state hydrogen storage device including a plate type heat exchanger 200 according to another form of the present disclosure. Referring to FIG. 3, the heater 201 may include a metal plate 220 and a heat radiating part 210.

The heat radiating part 210 may be included in the interior of the metal plate 220. The metal plate 220 may be provided at upper and lower portions of the heater 201, and the heat radiating part 210 may be included in the interior of the metal plate 220. The heater 201 may be vertically pressed while being inserted between the sold state hydrogen storage material 100.

The heat radiating part 210 is a heat emitting body such as a coil or a heating wire, and may generate heat to heat the solid state hydrogen storage material 100.

A contact surface of the metal plate 220 with the heat radiating part 210 may be coated with a metal of a high thermal conductivity such as copper or aluminum whereby the heat generated by the heat radiating part 210 may be effectively transferred to the solid state hydrogen storage material 100. Further, the contact surface may be coated with varnish or powder of a high thermal conductivity.

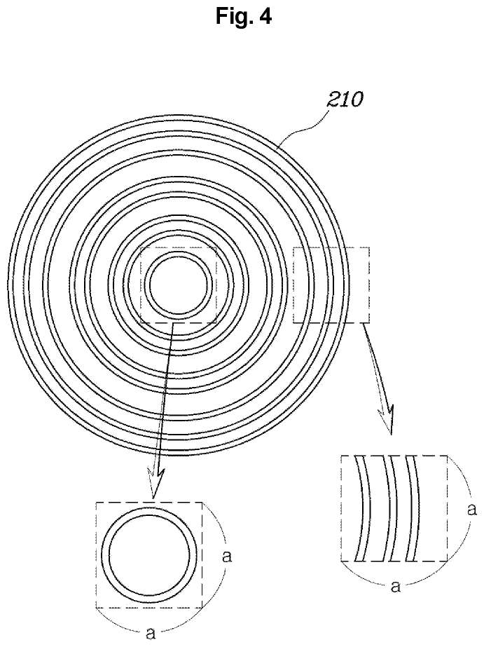

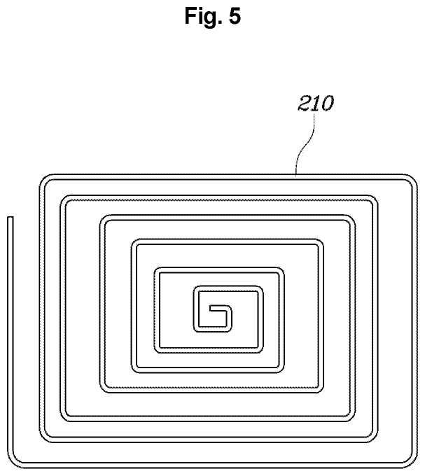

FIGS. 4 and 5 are views of a heat radiating part 210 of the solid state hydrogen storage device including a plate type heat exchanger 200 in one form of the present disclosure.

The heat radiating part 210 may be configured such that heat may be uniformly transferred to the entire area of the heater 201. In detail, the heat radiating part 210 may include a constant length per unit area of the solid state hydrogen storage material 100. The plate type heaters 201 that constitute the plate type heat exchanger 200 are desired to uniformly apply heat to the contact surface with the solid state hydrogen storage material 100. Accordingly, the heat radiating part 210 that is a heat radiating body include a constant length per unit area to uniformly provide thermal energy to the solid state hydrogen storage material 100, whereby the solid state hydrogen storage material 100 may maintain a uniform temperature.

Here, a unit area refers to a square area obtained by arbitrarily setting the length of an edge of the heat radiating part 210, and this will be understood clearly with reference to FIG. 4.

FIGS. 4 and 5 illustrate heat radiating parts 210 having different shapes.

Referring to FIG. 4, a plurality of circular heat radiating parts 210 may be provided. The plurality of circular heat radiating parts 210 draw concentric circles while the center of the heat exchanger 200 is taken as the centers thereof. In one form, the circular heat radiating parts are coaxially arranged around the center of the heat exchanger 200 with intervals such that among the plurality of circular heat radiating parts, a diameter of an outer circular heat radiating part is larger than a diameter of an inner circular heat radiating part.

The heat exchanger parts 210 may be disposed at irregular intervals. Since the lengths of the heat radiating parts 210 included in a unit area are different whereby heat cannot be uniformly transferred if the heat radiating parts 210 are disposed at a regular interval, the heat exchanger parts 210 may be disposed at irregular intervals to include a constant length per unit area.

Referring to FIG. 5, the heat radiating part 210 may include a bent heating wire such that polygons are repeated while the center of the heat exchanger 200 is taken as centers thereof. As illustrated in FIG. 5, the heating wire may be bent such that the rectangular shapes are repeated. In this case, the intervals of the polygons may be irregular such that the polygons include a constant length per unit area. The polygons are not limited to rectangular shapes.

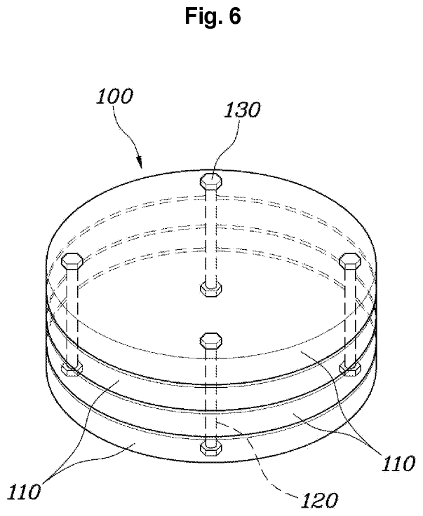

FIG. 6 is a perspective view of a solid state hydrogen storage material 100 of the solid state hydrogen storage device including a plate type heat exchanger 200 according to one form of the present disclosure.

Referring to FIG. 6, the solid state hydrogen storage material 100 may has a stack structure in which a plurality of disks 110 are stacked. Heat exchangers 200 may be inserted between the plurality of disks 110 such that heat may be exchanged by the mutual contact surfaces.

The cross-sections of the heat exchangers 200 and the disks 110 may be configured to be the same. Since the cross-sections are the same, the contact surfaces coincide with each other, and heat can be effectively exchanged. The heat conductivity of the heat exchanger 200 may become higher as the area becomes wider and the thickness becomes smaller. Accordingly, the contact surfaces can be made maximal by making the cross-section of the plate type heat exchanger 200 the same as that of the solid state hydrogen storage material 100, and the thermal conductivity can be improved by making the thickness smaller.

Further, as illustrated in FIG. 6, compression members 120 may be inserted between the stacked disks 110. The compression members 120 may be inserted upwards and downwards between the disks and the heat exchangers 200, which have been stacked, and opposite ends of the compression members 120 may be provided with sealing members 130. The compression members 120 and the sealing members 130 are coupled to each other through screw-couplings such that the solid state hydrogen storage material 100 can be compactly compressed while the sealing members 130 press the disks 110 upwards and downwards. A plurality of compression members 120 may be provided.

The solid state hydrogen storage material 100 may be contracted or expanded in volume as the hydrogen is stored or discharged. In the conventional technology, the device should be assembled with tolerances in preparation for a case of a changed volume. However, in the present disclosure, the shape of the device can be maintained and heat can be uniformly exchanged as the plate-shaped heat exchanger 200 is inserted and the solid state hydrogen storage material 100 is pressed by the compression members 120.

Although the present disclosure has been described and illustrated in conjunction with particular forms thereof, it will be apparent to those skilled in the art that various improvements and modifications may be made to the present disclosure without departing from the technical idea of the present disclosure.

What is claimed is:

1. A solid state hydrogen storage device comprising:
a solid state hydrogen storage material in which hydrogen is stored;
a heat exchanger forming a plate shape and configured to: be inserted into the solid state hydrogen storage material and exchange heat with the solid state hydrogen storage material through contact with the solid state hydrogen storage material;
a storage container configured to accommodate the solid state hydrogen storage material and the heat exchanger; and
a cap connected to an upper portion of the storage container and configured to seal an interior of the storage container.

2. The solid state hydrogen storage device of claim 1, wherein:
the heat exchanger comprises a plurality of plate type heaters,
plate type heaters of the plurality of plate type heaters are disposed upwards and downwards at a regular interval, and
the solid state hydrogen material is inserted between the plate type heaters.

3. The solid state hydrogen storage device of claim 2, wherein:
each of the plate type heaters is provided with metal plates respectively disposed on an upper side and a lower side thereof,
each of the plate type heaters comprises a heat radiating part configured to radiate heat in an interior thereof, and
the heat radiating part has a constant length per unit area.

4. The solid state hydrogen storage device of claim 3, wherein a surface of each of the metal plates is configured to contact the heat radiating part and be coated with copper or aluminum.

5. The solid state hydrogen storage device of claim 3, wherein the heat radiating part comprises a plurality of circular heat radiating parts coaxially arranged around a center of the heat exchanger with irregular intervals such that among the plurality of circular heat radiating parts, a diameter of an outer circular heat radiating part is larger than a diameter of an inner circular heat radiating part.

6. The solid state hydrogen storage device of claim 3, wherein the heat radiating part comprises heating wires having bent shapes, in which polygonal shapes are repeated while a center of the heat exchanger is taken as centers of the heating wires.

7. The solid state hydrogen storage device of claim 1, wherein:
the solid state hydrogen storage material comprises a plurality of disks and disks of the plurality of disks are stacked on one another, and
the heat exchanger is inserted between the disks to exchange heat with the disks.

8. The solid state hydrogen storage device of claim 7, wherein the solid state hydrogen storage material comprises a compression member inserted between the stacked disks and a sealing member that is configured to seal opposite ends of the compression member and press the disks upwards and downwards.

9. The solid state hydrogen storage device of claim 1, wherein the solid state hydrogen storage material is configured to store hydrogen in a form of at least one of LaNi₅H₆, sodium aluminum hydride (NaAlH₄), or magnesium amide (Mg(NH₂)₂).
